(19) United States
(12) Patent Application Publication
(10) Pub. No.: US 2026/0298634 A1
(43) Pub. Date: Oct. 1, 2026

(54) INERTIAL ANGULAR SENSOR WITH MICRO-MACHINED ELECTROMECHANICAL MICROSYSTEM

(71) Applicant: THALES, Meudon (FR)

(72) Inventors: Bertrand LEVERRIER, VALENCE (FR); Fabien FILHOL, VALENCE (FR); Alexandre AZIER, VALENCE (FR); Nicolas Jean-Marc Frédéric VERCIER, VALENCE (FR)

(21) Appl. No.: 19/489,932

(22) PCT Filed: Jun. 13, 2024
(86) PCT No.: PCT/EP2024/066403

§ 371 Date: Dec. 4, 2025

(30) Foreign Application Priority Data
Jun. 13, 2023 (FR) FR2306004

(51) Int. Cl. G01C 19/5712

(52) U.S. Cl. CPC G01C 19/5712

(57) ABSTRACT

An angular sensor including a support plate, an inner mass suspended from the support plate at fixed anchor points and suitable for vibrating in a plane, an outer mass, which encloses the inner mass, is coupled to the inner mass and is suitable for vibrating in the plane, and an outer frame, which is arranged above the support plate in relation to an axis and encloses the inner mass and the outer mass. The angular sensor further includes an inner frame arranged between the outer mass and the outer frame, fixed to the support plate by an electrically insulating element, the outer mass being suspended at fixed anchoring points of the inner frame and being electrically connected to the inner frame by first suspension elements.

The present invention relates to an inertial angular sensor with a micro-machined electromechanical microsystem.

Such angular sensors are used for measuring an angular position or an angular velocity. In the first case, these sensors function as gyroscopes, and in the second case, they function as gyrometers. These sensors are micro-machined on silicon or quartz wafers, using techniques similar to integrated circuit manufacturing. This allows for low production costs and thus various application fields.

Inertial angular sensors generally comprise several vibrating mobile masses, elastically connected to a support and elastically coupled to each other by elements functioning as springs. It is known from the prior art to use silicon beams for these elements. The assembly formed by the masses and the elements functioning as springs forms a resonator that can advantageously be vibrated on its natural modes by excitation systems, which can be electrical excitation systems. This excitation causes the masses to vibrate in the plane of the plate and perpendicularly to a direction called the “sensitive axis” of the angular sensor, which is thus perpendicular to the plane of the plate.

When the angular sensor has a certain rotational speed around the sensitive axis, the Coriolis effect generates a force that makes the masses vibrate in a direction perpendicular to the excitation direction, still in the plane of the plate. Measuring this vibration allows the rotational speed to be deduced.

As mentioned earlier, the masses are excited by electrical excitation systems. For example, systems with two concentric masses, an inner mass and an outer mass surrounding the inner mass, are known.

The electrical systems are, for example, electrodes, and in particular fixed electrodes associated with mobile electrodes, which are, for example, directly carried by the masses.

The masses are at the same electrical potential, as they are coupled to each other by coupling elements that are often made of electrically conductive material. This electrical potential can be non-zero if an electrical voltage is applied to the mobile electrodes, for example, to facilitate the detection of vibrations.

The masses are generally elastically connected to a support via an insulating layer, for example, made of silicon oxide.

The outer mass is surrounded by an external frame that constitutes the exterior of the silicon chip. This frame is set to a fixed electrical potential to shield the sensitive part with lower and upper silicon layers (bulk and cap).

In this case, a potential difference is imposed between the outer mass and the frame, creating electrostatic stiffness, which leads to a modification of an apparent stiffness of a half-resonator formed by the outer mass and the elements connecting it to the support. The modification of the apparent stiffness of the half-resonator creates a stiffness imbalance that alters the balancing of the resonator.

This phenomenon is also called “electrostatic trimming” and, while it can be used intentionally to compensate for defects in the masses, it creates an imbalance in the vibrating structure, making it particularly sensitive to external vibrations. Due to this modification of the apparent stiffness of the half-resonator, the sensor no longer functions optimally for determining rotational speed.

It is therefore necessary to optimize the functioning of the sensors, comprising when there is an electrical potential difference between the masses and the frame surrounding the outer mass.

The present invention aims to solve this drawback by proposing an inertial angular sensor insensitive to the presence of an electrical potential difference between the masses and the external frame.

To this end, the invention comprises an inertial angular sensor with a micro-machined electromechanical microsystem comprising:
a support plate;
an inner mass suspended at fixed anchoring points of the support plate and adapted to vibrate in a plane substantially parallel to the support plate;
an outer mass enclosing the inner mass, coupled to the inner mass and adapted to vibrate in the plane substantially parallel to the support plate;
an external frame arranged above the support plate relative to an axis and enclosing the inner and outer masses;

characterized in that the sensor further comprises an internal frame arranged between the outer mass and the external frame and fixed to the support plate by an electrically insulating element, the outer mass being suspended at fixed anchoring points of the internal frame and being electrically connected to the internal frame by first suspension elements.

By means of the invention, the outer mass is connected to a fixed internal frame that is electrically isolated from the external frame and thus has the same electrical potential as the inner and outer masses. Thus, there is no longer an electrical voltage applied between the outer mass and the frame surrounding it. The apparent stiffness, i.e., the sum of the mechanical and electrostatic stiffnesses of an external half-resonator formed by the outer mass and the first suspension elements, is therefore not modified when an electrical voltage is applied to the masses. The sensor is therefore not unbalanced, and no energy coupling with the support is created during the vibration of the masses. In other words, the phenomenon of “electrostatic trimming” is minimized or even eliminated. The functioning of the sensor is therefore identical regardless of the voltage applied and remains optimal regardless of the voltage applied to the masses.

The sensor may comprise one or more of the following features, taken individually or in any technically possible combination:
The inner mass is suspended at the fixed anchoring points of the support plate by second suspension elements, and the outer mass is coupled to the inner mass by coupling elements.
The first and second suspension elements and the coupling elements are silicon beams.
The external frame is connected to an electrical mass.
Mechanical and/or electrostatic forces applied to the inner mass are substantially equal to mechanical and/or electrostatic forces applied to the outer mass.
This sensor further comprises at least one mobile electrode carried by one of the inner and outer masses, and at least one fixed electrode, the or each fixed electrode being fixed relative to the support plate (4) and facing one of the at least one mobile electrode.
When the inner and outer masses are at rest, their centers of gravity coincide, and an assembly consisting of the inner and outer masses and each mobile electrode is symmetrical with respect to a first axis parallel to the support plate, passing through the center of gravity of the two masses, and with respect to a second axis parallel to the support plate, perpendicular to the first axis (X) and passing through the center of gravity of the two masses.
Mechanical and/or electrostatic forces applied to the inner mass along the first and second axes are substantially equal to mechanical and/or electrostatic forces applied to the outer mass along the first and second axes, respectively.
This sensor further comprises:
four mobile excitation electrodes, two of the four mobile excitation electrodes being carried by the inner mass and the other two mobile excitation electrodes being carried by the outer mass;
four mobile detection electrodes, two of the four mobile detection electrodes being carried by the inner mass and the other two mobile detection electrodes being carried by the outer mass; and
eight fixed electrodes, each fixed electrode being fixed relative to the support plate and facing one of the eight mobile electrodes.
The four excitation electrodes and/or the four detection electrodes are configured to be traversed by a non-zero continuous voltage and/or an amplitude-modulated alternating voltage.
This sensor further comprises a silicon cap covering the external frame, the internal frame, the outer mass, and the inner mass.
This sensor further comprises an electrically insulating layer arranged on the faces of the external frame in contact with the cap and the support plate, respectively.

The invention will be better understood by reading the following description, given solely as a non-limiting example and referring to the drawings wherein:

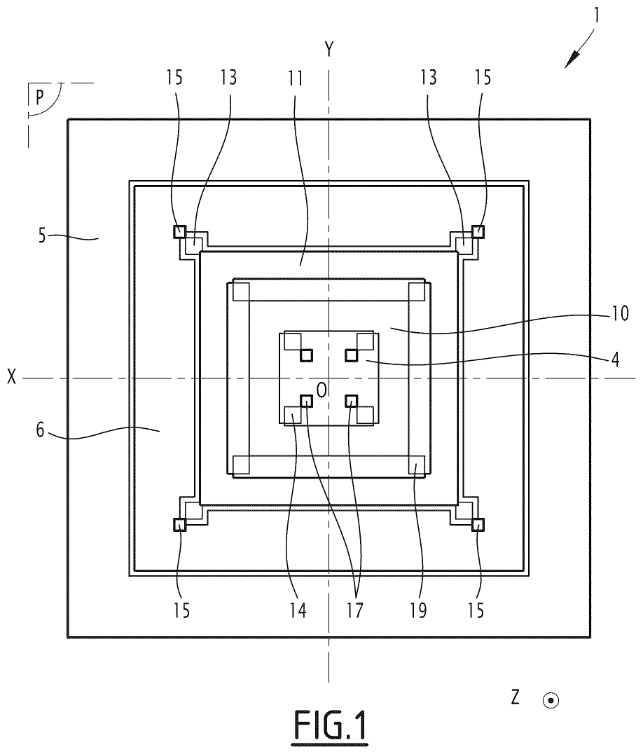

FIG. 1 is a schematic top view of the inertial angular sensor with a micro-machined electromechanical microsystem, according to the invention;

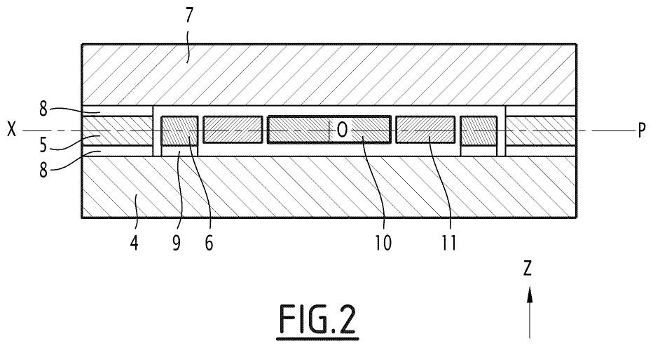

FIG. 2 is a cross-sectional view of the inertial angular sensor with a micro-machined electromechanical microsystem shown in FIG. 1;

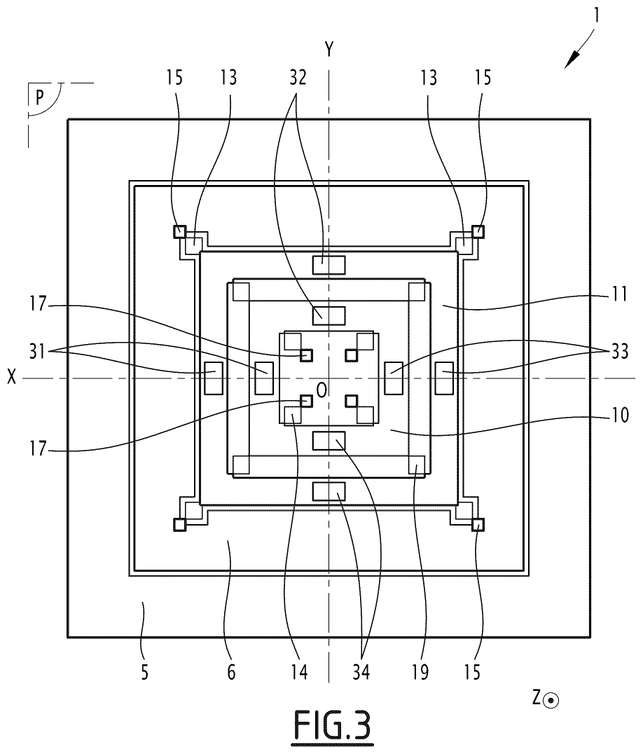

FIG. 3 is a view similar to that shown in FIG. 1 where additional elements are visible.

FIGS. 1 to 3 show an inertial angular sensor with a micro-machined electromechanical microsystem 1, hereinafter referred to as angular sensor 1.

The angular sensor 1 being micro-machined, it forms a micro-electromechanical system, also called MEMS, the acronym for “Micro-Electromechanical Systems”.

The angular sensor 1 is, for example, a gyrometer configured to measure an angular velocity. Alternatively or additionally, the angular sensor 1 is a gyroscope configured to measure an angular position.

The angular sensor 1 is intended, in particular, to be embedded in a vehicle (not shown) which is, for example, an aircraft, a drone, or a ship, more particularly in a navigation, piloting, or guidance system of the vehicle.

The angular sensor 1 is here a tuning fork type gyrometer, more specifically a tuning fork type gyrometer with two vibrating masses. According to an alternative not shown, the angular sensor may comprise more than two vibrating masses.

The term “vibrating mass” means that the two masses are capable of oscillating, whether due to excitation or by the Coriolis effect during a rotation of the angular sensor 1.

The angular sensor 1 comprises a support plate 4, an external frame 5, an internal frame 6, a cap 7, an inner mass 10, and an outer mass 11.

The support plate 4 extends parallel to a plane P defined by a first axis X and a second axis Y perpendicular to the first axis X, linked to the support plate 4. The support plate 4 is typically made of silicon but may optionally be made of glass.

Above the support 4 relative to an axis Z, perpendicular to the first axis X and the second axis Y, thus perpendicular to the plane P, are arranged the external frame 5 and the internal frame 6.

An electrical potential of the external frame 5 is kept fixed. Advantageously, the electrical potential of the external frame 5 is kept zero, meaning that the external frame is electrically connected to an electrical mass. The external 5 and internal 6 frames are typically made of electrically conductive material, for example, doped silicon.

The cap 7 covers the external frame 5, the internal frame 6, the inner mass 10, and the outer mass 11. Advantageously, the cap 7 is made of silicon, but it may optionally be made of glass.

The external frame 5 is separated from the support 4 and the cap 7 by an electrically insulating layer 8, for example, made of silicon oxide. This electrically insulating layer 8 is arranged on a face of the external frame 5 in contact with the support plate 4 on one hand, and on a face of the external frame 5 in contact with the cap 7 on the other hand. This allows for electrical shielding, thus protecting the angular sensor 1 from parasitic electromagnetic waves that could alter its functioning or even damage it.

The internal frame 6 is enclosed by the external frame 5 and is fixed to the support plate 4 by an electrically insulating element 9. Alternatively, the internal frame 6 is fixed to both the support plate 4 and the cap 7. This electrically insulating element 9 may be identical to the electrically insulating layer 8, in particular, the electrically insulating element 9 is of a material and thickness, measured along the axis Z, identical to those of the electrically insulating layer 8. Advantageously, the electrically insulating layer 8 and the electrically insulating element 9 are both made of silicon oxide.

Thanks to this electrically insulating element 9, the internal frame 6 can be at a different electrical potential from the support 4.

The inner 10 and outer 11 masses are the vibrating masses of the angular sensor 1. The outer mass 11 is arranged around the inner mass 10. The inner and outer masses 10 and 11 are enclosed by the internal frame 6, thus also enclosed by the external frame 5. The inner 10 and outer 11 masses are, for example, made of silicon and are mobile relative to the support plate 4 and mobile relative to each other.

The inner 10 and outer 11 masses each have a center of gravity, which, when the angular sensor 1 is at rest, meaning when the inner 10 and outer 11 masses are not vibrating, are substantially coincident at point O. Point O is also the intersection point of the axes X and Y.

The term “substantially,” here and in the rest of the text, means that a deviation of 10% from the announced value is allowed.

Advantageously, the inner 10 and outer 11 masses have substantially the same mass.

The inner 10 and outer 11 masses are adapted to vibrate in the plane P defined by the axes X and Y. Thus, the angular sensor 1 has the axis Z as its sensitive axis. In other words, the angular sensor 1 is adapted to measure a rotation or a rotational speed around the axis Z.

The angular sensor 1 further comprises first suspension elements 13 and second suspension elements 14.

The first suspension elements 13 connect the outer mass 11 to the internal frame 6, more particularly to fixed anchoring points 15 of the internal frame 6.

These first suspension elements 13 are advantageously four in number, as shown in FIGS. 1 and 3.

These first suspension elements 13 are assimilated to springs and can be either springs or, preferably, beams, particularly made of silicon. In the case where the first suspension elements 13 are silicon beams, the outer mass 11 and the internal frame 6 are mechanically and electrically connected to each other. They are notably at the same electrical potential.

The second suspension elements 14 connect the inner mass 10 to the support plate 4, by fixed anchoring points 17 of the support plate 4. These second suspension elements 14 are advantageously four in number, are advantageously similar to the first suspension elements 13, and are notably silicon beams. A layer of an electrically insulating material (not shown), is interposed along the axis Z between the fixed anchoring points 17 and the support plate 4. It is advantageously similar to the electrically insulating element 9.

Advantageously, the first and second suspension elements 13 and 14 have substantially equal stiffnesses.

The inner 10 and outer 11 masses are also connected to each other by coupling elements 19. These coupling elements 19 are advantageously four in number and are advantageously silicon beams, suited to behave like springs. In this latter case, the inner 10 and outer 11 masses are electrically and mechanically coupled to each other. They are thus notably at the same electrical potential. An additional electrostatic stiffness to a mechanical stiffness of the suspension elements 13, 14 can be generated if two surfaces mobile relative to each other and connected to one of the suspension elements 13 or 14 are placed in an electric potential field, for example, created by two pieces having a potential difference.

In the present case, the inner 10 and outer 11 masses are coupled to each other, the outer mass 11 is connected to the internal frame 6, which is electrically isolated from the support plate 4 and the external frame 5. Thus, the inner 10, outer 11 masses, and the internal frame 6 are at the same electrical potential. The electrical voltage between a perimeter of the outer mass 11 and an interior of the internal frame 6 is therefore zero, and the first suspension elements 13 do not undergo the appearance of an electrostatic stiffness.

The angular sensor 1, as shown in FIG. 3, further comprises electrodes. In FIG. 3, eight mobile electrodes are shown, four electrodes on the inner mass 10 and four on the outer mass 11.

In FIG. 3, mobile excitation electrodes 31 along the axis X, mobile excitation electrodes 32 along the axis Y, mobile detection electrodes 33 along the axis X, and mobile detection electrodes 34 along the axis Y are shown. The positioning of the mobile electrodes 31, 32, 33, and 34 can vary, and in particular, according to a variant not shown, the electrode(s) 31 may be at the location of the electrode(s) 34.

The mobile electrodes 31, 32, 33, and 34 are not shown in FIG. 1, but they are advantageously present as in FIG. 3. Eight fixed electrodes are facing the mobile electrodes but are not shown. The fixed and mobile electrodes are formed, for example, by interdigitated combs. A fixed electrode-mobile electrode pair forms an electromechanical transducer.

The electromechanical transducers, which comprise the mobile electrodes 31, 32, 33, 34, are capable of converting an electrical voltage into motion and/or vice versa.

In particular, the mobile excitation electrodes 31 and 32 are capable of generating the vibration of the inner 10 and outer 11 masses, along the axes X and Y respectively, by applying electrostatic forces to the mass on which the electrode is arranged.

For this, an alternating voltage is advantageously applied between the electrodes 31 and 32 and the fixed electrodes they are respectively facing. The frequency of this voltage is substantially equal to the mechanical resonance frequency of the inner 10 and outer 11 masses, called the tuning fork frequency. This causes the inner 10 and outer 11 masses to vibrate at this frequency.

The electromechanical transducers, which comprise the mobile detection electrodes 33 and 34, are capable of detecting the vibration of the inner 10 and outer 11 masses along the axes X and Y respectively. For this, a continuous voltage, called polarization voltage, is advantageously applied between each mobile detection electrode 33 and 34 and the fixed electrodes they are respectively facing. Variations in charge between the mobile and fixed electrodes, due to the movement of the inner 10 and outer 11 masses, are measured and allow the movement of the inner 10 and outer 11 masses to be deduced.

Of course, other electrodes than those shown in FIG. 3 can be added to the inner 10 and outer 11 masses, such as electrodes for compensating a quadrature bias or frequency.

In practice, the electrodes and transducers used in inertial angular sensors with micro-machined electromechanical microsystems are known per se and are not limiting. Notably, other positions of the electrodes and other principles of excitation and detection can be used. For example, the mobile electrodes 31 to 34 can be traversed by an alternating voltage whose amplitude is modulated, to facilitate the detection of vibrations by the detection electrodes 33 and 34.

The angular sensor 1 shown in FIGS. 1 to 3 presents symmetry along the axes X and Y when at rest. In particular, an assembly consisting of the inner 10, outer 11 masses, and the fixed and mobile electrodes 31 to 34 is symmetrical with respect to the axes X and Y, in the absence of vibration of the masses 10 and 11. However, according to a variant not shown, this assembly is not symmetrical with respect to the axes X and Y.

The functioning of the angular sensor 1 will now be explained.

The angular sensor is excited, meaning that an excitation voltage is applied between the electrodes 31 and 32 and the fixed electrodes they are facing. The excitation voltage generates electrostatic forces that set the inner 10 and outer 11 masses in motion, which begin to vibrate. As mentioned earlier, this vibration occurs in the plane P.

We note:

$$Xi = [ \begin{matrix}x i \\ y i\end{matrix} ]$$

the translational displacement of the inner mass 10, of mass Mi in the plane P;

$$Xe = [ \begin{matrix}xe \\ ye\end{matrix} ]$$

the translational displacement of the outer mass 11, of mass Me in the plane P;

$$K i = [ \begin{matrix}K x i & K x y i \\ K x y i & K y i\end{matrix} ]$$

the sum of the stiffnesses associated with an internal half-resonator formed by the second suspension elements 14 and the inner mass 10 on the resonance modes in translation in the plane P, i.e., the sum of the mechanical stiffnesses and the electrostatic stiffnesses applied to the mass Mi;
Kxi is the sum of the stiffnesses on the axis X of the second suspension elements 14 connecting the inner mass 10 to the support 4, similarly for Kyi but for the axis Y;
Kxyi represents a coupling stiffness between the axis X and the axis Y. The coupling stiffness is associated with a force in quadrature with the movement of the inner 10 and outer 11 masses.

$$K e = [ \begin{matrix}K x e & K x y e \\ K x y e & K y e\end{matrix} ]$$

the sum of the stiffnesses associated with an external half-resonator formed by the first suspension elements 13 and the outer mass 11 on the resonance modes in translation in the plane P, i.e., the sum of the mechanical stiffnesses and the electrostatic stiffnesses applied to the mass Me;
F=the excitation forces. In practice, other forces may apply, notably the forces due to the Coriolis effect, when the angular sensor is rotating around the axis Z, or damping forces.

By applying the fundamental principle of dynamics to the system, we obtain:

$$Mi \cdot \ddot{X} i + Ki \cdot Xi = Fi$$

$$Me \cdot \ddot{X} e + Ke \cdot Xe = Fe$$

Then by combining the first terms Mi. \ddot{X}i and Me. \ddot{X}e:

$$Mi \cdot \ddot{X} i - Me \cdot \dot{X} e = ( M i - M e ) \frac{( \ddot{X} ι + \ddot{Xe} )}{2} + \frac{M i + M e}{2} ( \ddot{X} ι - \ddot{Xe} ) .$$

This equation presents an in-phase acceleration

$$\frac{( \ddot{X} i + \ddot{Xe} )}{2} ,$$

associated with the mass difference between the inner 10 and outer 11 masses, and an out-of-phase acceleration, called tuning fork (\ddot{X}i−\ddot{X}e), which is associated with an average mass

$$\frac{M i + M e}{2} .$$

By combining the second terms, we obtain:

$$K i X i - K e X e = ( K i - K e ) \frac{( X i + X e )}{2} + \frac{K i + K e}{2} ( X i - X e )$$

This equation presents an in-phase movement

$$\frac{( X i + X e )}{2} ,$$

associated with the stiffness difference between the external and internal half-resonators, and an out-of-phase movement (Xi−Xe), which is associated with an average stiffness

$$\frac{K i + K e}{2} .$$

So, by combining the two previous equations:

$$\frac{M i + M e}{2} ( \ddot{X ι} - \ddot{Xe} ) + \frac{K i + K e}{2} ( X i - X e ) = F i - F e - ( M i - M e ) \frac{( \ddot{X ι} + \ddot{Xe} )}{2} - ( K i - K e ) \frac{( X i + X e )}{2}$$

In the case where the mass of the inner 10 and outer 11 masses is not substantially the same, or in the case where the mechanical stiffness of the first suspension elements 13 and the second suspension elements 14 is not substantially the same, or again, in the case where the electrostatic stiffnesses applied to the inner 10 and outer 11 masses are not equal, the angular sensor 1 is unbalanced. In this case, when the angular sensor 1 is subjected to external vibrations whose frequency is substantially equal to the tuning fork frequency, in-phase and out-of-phase modes, associated with the in-phase and out-of-phase movement and acceleration described, are excited simultaneously, which degrades the functioning of the angular sensor 1.

The sum of the stiffnesses Ke associated with the external half-resonator depends on the mechanical stiffness of the first suspension elements 13, but also on the electrical voltages applied between the external half-resonator and the fixed electrodes or the internal frame 6. Similarly, the sum of the stiffnesses Ki associated with the internal half-resonator depends on the mechanical stiffness of the second suspension elements 14, but also on the electrical voltages applied between the external half-resonator and the fixed electrodes.

We have seen previously that advantageously, the first and second suspension elements 13 and 14 have substantially equal mechanical stiffnesses. On the other hand, according to the invention, the suspension elements 13 and 14, the inner 10, outer 11 masses, the internal frame 6, and the coupling elements 19 are all substantially at the same electrical potential, as explained previously. In this case, the sum of the stiffnesses associated with the two half-resonators are therefore substantially equal, thus rendering the functioning of the angular sensor 1 optimal. In other words, the terms Ki and Ke are substantially equal, so the term associated with the in-phase movement

$$\frac{( X i + X e )}{2}$$

disappears.

Thus, in the angular sensor 1 described above, mechanical and/or electrostatic forces related to the mechanical and/or electrostatic stiffnesses applied to the inner mass 10 along the first and second axes X and Y are substantially equal to mechanical and/or electrostatic forces related to the mechanical and/or electrostatic stiffnesses applied along the first and second axes X and Y respectively to the outer mass 11.

In the case where the angular sensor 1 does not present symmetry along the first and second axes X and Y, the mechanical and/or electrostatic forces applied to the inner mass 10 are substantially equal to the mechanical and/or electrostatic forces applied to the outer mass 11.

The internal frame 6 thus makes it possible to not create an additional electrostatic stiffness that would need to be corrected by adding additional electrodes that generate electrostatic forces countering this electrostatic stiffness.

When a rotation of the angular sensor 1 occurs around the axis Z, the Coriolis effect induces additional forces that generate an additional vibration of the inner 10 and outer 11 masses along the directions X and Y. The amplitude of this vibration is proportional to the rotational speed of the angular sensor 1 around the axis Z. The overall movement of the inner 10 and outer 11 masses is detected by the transducers, which comprise the detection electrodes 33 and 34. The processing of the signal thus received then allows the angular speed or the angular position of the angular sensor 1 to be deduced.

Thus, the internal frame 6 and the outer mass 11 being substantially at the same electrical potential, no electrostatic stiffness is created that adds to the mechanical stiffness of the first suspension elements 13. The sum of the stiffnesses associated with the inner mass 10 and the sum of the stiffnesses associated with the outer mass 11 are therefore substantially equal. The angular sensor 1 presented above does not see its functioning disturbed by an imbalance caused by a stiffness difference. The angular sensor 1 thus functions reliably, independently of the electrical voltage applied to the electrodes 31 to 34.

1. An inertial angular sensor with a micro-machined electromechanical microsystem comprising:
a support plate;
an inner mass suspended at fixed anchoring points of the support plate and adapted to vibrate in a plane substantially parallel to the support plate;
an outer mass enclosing the inner mass, coupled to the inner mass and adapted to vibrate in the plane substantially parallel to the support plate;
an external frame arranged above the support plate relative to an axis, perpendicular to the plane and enclosing the inner mass and the outer mass;
wherein the angular sensor further comprises an internal frame arranged between the outer mass and the external frame and fixed to the support plate by an electrically insulating element, the outer mass being suspended at fixed anchoring points of the internal frame and being electrically connected to the internal frame by first suspension elements.

2. The angular sensor according to claim 1, wherein the inner mass is suspended at the fixed anchoring points of the support plate by second suspension elements, and the outer mass is coupled to the inner mass by coupling elements.

3. The angular sensor according to claim 2, wherein the first and second suspension elements and the coupling elements are silicon beams.

4. The angular sensor according to claim 1, wherein the external frame is connected to an electrical mass.

5. The angular sensor according to claim 1, further comprising at least one mobile electrode carried by one of the inner mass and the outer mass, and at least one fixed electrode, the or each fixed electrode being fixed relative to the support plate and facing one of the at least one mobile electrode.

6. The angular sensor according to claim 1, wherein, when the inner mass and the outer mass are at rest, their centers of gravity coincide, and wherein an assembly consisting of the inner and outer masses and the or each mobile electrode is symmetrical with respect to a first axis parallel to the support plate, passing through the center of gravity of the two masses, and with respect to a second axis parallel to the support plate, perpendicular to the first axis and passing through the center of gravity of the two masses.

7. The angular sensor according to claim 1, further comprising:
four mobile excitation electrodes, two of the four mobile excitation electrodes being carried by the inner mass and the other two mobile excitation electrodes being carried by the outer mass;
four mobile detection electrodes, two of the four mobile detection electrodes being carried by the inner mass and the other two mobile detection electrodes being carried by the outer mass; and
eight fixed electrodes, each fixed electrode being fixed relative to the support plate, and facing one of the eight mobile electrodes.

8. The angular sensor according to claim 7, wherein the four excitation electrodes and/or the four detection electrodes are configured to be traversed by a non-zero continuous voltage and/or an amplitude-modulated alternating voltage.

9. The angular sensor according to claim 1, further comprising a silicon cap, covering the external frame, the internal frame, the outer mass, and the inner mass.

10. The angular sensor according to claim 9, further comprising an electrically insulating layer arranged on the faces of the external frame in contact with the cap and the support plate, respectively.
